(19) United States
(12) Patent Application Publication
(10) Pub. No.: US 2022/0018372 A1
(43) Pub. Date: Jan. 20, 2022

(54) Table Assembly and Method for Assembling Thereof

(71) Applicant: EP Family Corp., Walnut, CA (US)

(72) Inventor: Chin-Hung Shyu, Walnut, CA (US)

(21) Appl. No.: 16/930,538

(22) Filed: Jul. 16, 2020

(51) Int. Cl. F16B 12/44; A47B 13/08; A47B 3/06; F16B 12/10

(52) U.S. Cl. CPC F16B 12/44; A47B 13/088; F16B 2012/106; F16B 12/10; A47B 3/06

(57) ABSTRACT

The table assembly comprises a first side wall, a second side wall, a first table top and a first support. The first side wall comprises a plurality of first side wall mortises. The second side wall comprises a plurality of second side wall mortises. The first table top comprises at least one first table top tenon. The first support comprises two first support tenons. The method comprises: coupling the first support to the first side wall by coupling one of the first support tenons to the first side wall mortise; coupling the first support to the second side wall by coupling another one of the first support tenons to the second side wall mortise; and coupling the first table top to the first side wall via coupling the first table top tenon to the first side wall mortise, wherein the first table top is supported by the first support.

### TECHNICAL FIELD OF THE INVENTION

The present application generally relates to tables, and more particularly, to a table assembly and a method for assembling thereof.

### BACKGROUND OF THE INVENTION

There are many different styles of tables such as dining table or conference table. Some of them are one-pieced while some of them are assembled. For one-pieced table, the transportation is not easy since the overall size is too large. For the assembled table, it is required to assemble multiple components such as four vertical legs, four horizontal rods and table tops. In addition, the fixing components such as screws, nails or hammer are required for assembling. The process is cumbersome and easy to lose small elements such as screw nut.

Therefore, a need remains for a table assembly and method for assembling thereof to provide a convenient transportation and easily assembled structure.

### SUMMARY OF THE INVENTION

The present application discloses a table assembly and method for assembling thereof to provide a convenient transportation and easily assembled structure.

The table assembly comprises a first side wall, a second side wall and a table top. The first side wall comprises at least one first side wall mortise. The second side wall comprises at least one second side wall mortise. The table top comprises at least one first table top tenon at one edge and at least one second table top tenon at an opposite edge, the table assembly is assembled via coupling the at least one first table top tenon to the at least one first side wall mortise and coupling the at least one second table top tenon to the at least one second side wall mortise.

In various exemplary embodiments, wherein the first side wall comprises two first side wall mortises and the second side wall comprises two second side wall mortises, the table top comprises two first table top tenons and two second table top tenons.

In various exemplary embodiments, the table assembly further comprises a support comprising two support tenons. The first side wall comprises at least two first side wall mortises and the second side wall comprises at least two second side wall mortises. The support is coupled to the first side wall via coupling one of the support tenons to one of the first side wall mortise and coupling another one of the support tenons to one of the second side wall mortises. The table top is coupled to the first side wall via coupling the first table top tenon to another one of the first side wall mortises and coupling the second table top tenon to another one of the second side wall mortises.

In various exemplary embodiments, the table assembly further comprises a reinforcement comprising two reinforcement tenons. The first side wall comprises at least two first side wall mortises and the second side wall comprises at least two second side wall mortises. The reinforcement is coupled to the first side wall via coupling one of the reinforcement tenons to one of the first side wall mortise and coupling another one of the reinforcement tenons to one of the second side wall mortises. The table top is coupled to the first side wall via coupling the first table top tenon to another one of the first side wall mortises and coupling the second table top tenon to another one of the second side wall mortises.

A method for assembling a table assembly is also disclosed. The table assembly comprises a first side wall, a second side wall, a first table top and a first support. The first side wall comprises a plurality of first side wall mortises. The second side wall comprises a plurality of second side wall mortises. The first table top comprises at least one first table top tenon. The first support comprises two first support tenons. The method comprises: coupling the first support to the first side wall by coupling one of the first support tenons to the first side wall mortise; coupling the first support to the second side wall by coupling another one of the first support tenons to the second side wall mortise; and coupling the first table top to the first side wall via coupling the first table top tenon to the first side wall mortise, wherein the first table top is supported by the first support.

In various exemplary embodiments, the method further comprises coupling a first reinforcement to the first side wall, wherein the first reinforcement comprises two first reinforcement tenons, the first reinforcement is coupled to the first side wall by coupling one of the first reinforcement tenons to the first side wall mortise; and coupling another one of the first reinforcement tenons to the second side wall mortise of the second side wall.

In various exemplary embodiments, wherein before the step of coupling the support to the first side wall, the method further comprises: coupling a third side wall to the second side wall, wherein the third side wall comprises a plurality of third side wall mortises and the second side wall further comprises a plurality of second side wall tenons, the third side wall is coupled to the second side wall by coupling the second side wall tenons to the third side wall mortises.

In various exemplary embodiments of the above embodiment, wherein the table assembly further comprises a fourth side wall, a first shelf base and a second shelf base. The fourth side wall comprises a plurality of fourth side wall mortises. The first shelf base comprises a plurality of first shelf base tenons. The second shelf base comprises a plurality of second shelf base tenons. The method further comprises: coupling a first shelf base to the fourth side wall by coupling the first shelf base tenons to the fourth side wall mortises; and coupling a second shelf base to the fourth side wall by coupling the second shelf base tenons to the fourth side wall mortises.

In various exemplary embodiments of the above embodiment, the method further comprises coupling a second support to the third side wall, wherein the second support comprises two second support tenons, the second support is coupled to the third side wall by coupling one of the second support tenons to the third side wall mortise; and coupling another one of the second support tenons to the fourth side wall mortise of the fourth side wall.

In various exemplary embodiments of the above embodiment, the method further comprises coupling a second reinforcement to the third side wall, wherein the second reinforcement comprises two second reinforcement tenons, the second reinforcement is coupled to the third side wall by coupling one of the second reinforcement tenons to the third side wall mortise; and coupling another one of the second reinforcement tenons to the fourth side wall mortise of the fourth side wall.

In various exemplary embodiments of the above embodiment, wherein the table assembly further comprises a second table top, a corner table top and at least one connector. The second table top comprises a plurality of second table top tenons and at least one second table top side hole. The corner table top comprises a plurality of corner table top tenons and at least one corner table top side hole. The method further comprises: assembling the table top and the corner table top by inserting one end of the connector to the second table top side hole, and inserting another one end of the connector to the corner table top side hole.

In various exemplary embodiments of the above embodiment, wherein the table assembly further comprises a fixing plate comprising at least two fixing plate screw holes. The second table top further comprises at least one second table top screw hole. The corner table top further comprises at least one corner table top screw hole. The method further comprises screwing through one of the fixing plate screw holes and the second table top screw hole; and screwing through another one of the fixing plate screw holes and the corner table top screw hole.

In various exemplary embodiments of the above embodiment, after assembling the table top and the corner table top, the method further comprising: coupling the second table top to the fourth side wall by coupling the second table top tenons to the fourth side wall mortises; and coupling the corner table top to the third side wall by coupling the corner table top tenons to the third side wall mortises.

In various exemplary embodiments of the above embodiment, wherein the table assembly further comprises a fixing plate comprising at least two fixing plate screw holes. The first table top further comprises at least one first table top screw hole. The corner table top further comprises at least one corner table top screw hole. Before the step of coupling the second table top to the fourth side wall, the method further comprises screwing through one of the fixing plate screw holes and the corner table top screw hole. After coupling the corner table top to the third side wall, the method further comprises screwing another one of the fixing plate screw holes and the first table top screw hole.

In various exemplary embodiments of the above embodiment, wherein the table assembly further comprises a first shelf wall comprising a plurality of first shelf wall mortises. The method further comprises coupling the first shelf side wall to the second table top, the first shelf base and the second shelf base by coupling the second table top tenon, the first shelf base tenon and the second shelf base tenon to the first shelf side wall mortises.

In various exemplary embodiments of the above embodiment, wherein the table assembly further comprises a second shelf wall comprising a plurality of second shelf wall mortises. The method further comprises coupling the second shelf wall to the second table top, the first shelf base and the second shelf base by coupling the second table top tenon, the first shelf base tenon and the second shelf base tenon to the second shelf side wall mortises.

In various exemplary embodiments of the above embodiment, wherein the table assembly further comprises a sorter. The corner table top further comprises a sorter hole. The method further comprises inserting the sorter to the sorter hole.

In various exemplary embodiments of the above embodiment, wherein the table assembly further comprises a sorter. The first table top further comprises a sorter hole. The method further comprises inserting the sorter to the sorter hole.

Based on the above, the table assembly of the present application allows user to assemble the table assembly simply via coupling the tenons to the mortises. There is no need to prepare hammer or nails etc. by the user.

In addition, the location of the tenons and the mortises are interchangeable since the tenons and the mortises comprise at least one hole on each of them for fixing at the side wall, table top, drawer base etc. As such, the user may modify the overall structure and increase or decrease the tenons and the mortises by themselves for enhance the stability or change the style of the table assembly.

Numerous other advantages and features of the present application will become readily apparent from the following detailed description of disclosed embodiments, from the claims and from the accompanying drawings.

### BRIEF DESCRIPTION OF THE DRAWINGS

The objects, features and advantages of the present application will be more readily appreciated upon reference to the following disclosure when considered in conjunction with the accompanying drawings, wherein like reference numerals are used to identify identical components in the various views, and wherein reference numerals with alphabetic characters are utilized to identify additional types, instantiations or variations of a selected component embodiment in the various views, in which:

FIGS. 1A-1B show a structure of a tenon and a mortise utilized by a table assembly of the present application and a mechanism of assembling thereof.

FIGS. 2A-2C show a first embodiment of the table assembly of the present application and a method of assembling thereof.

FIGS. 3A-12B show a second embodiment of the table assembly of the present application and a method of assembling thereof.

### DETAILED DESCRIPTION OF DISCLOSED EMBODIMENTS

Reference will now be made in detail to the present representative embodiments of the present application, examples of which are illustrated in the accompanying drawings. Wherever possible, the same reference numbers are used in the drawings and the description to refer to the same or like parts.

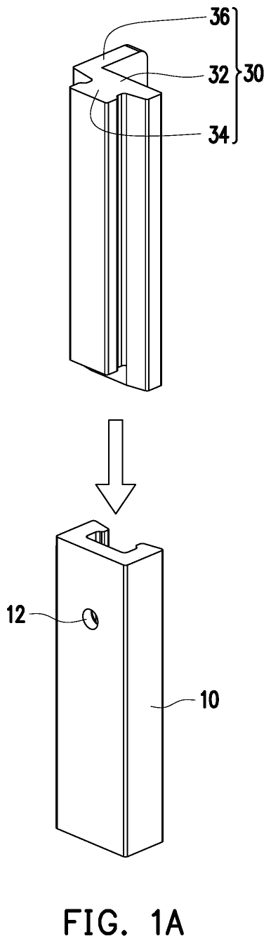

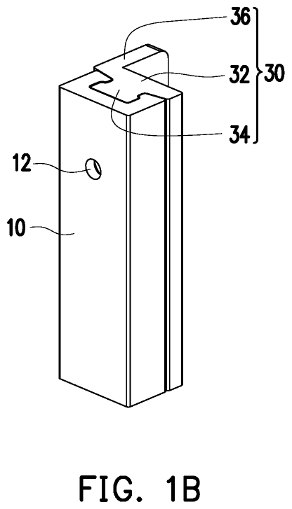

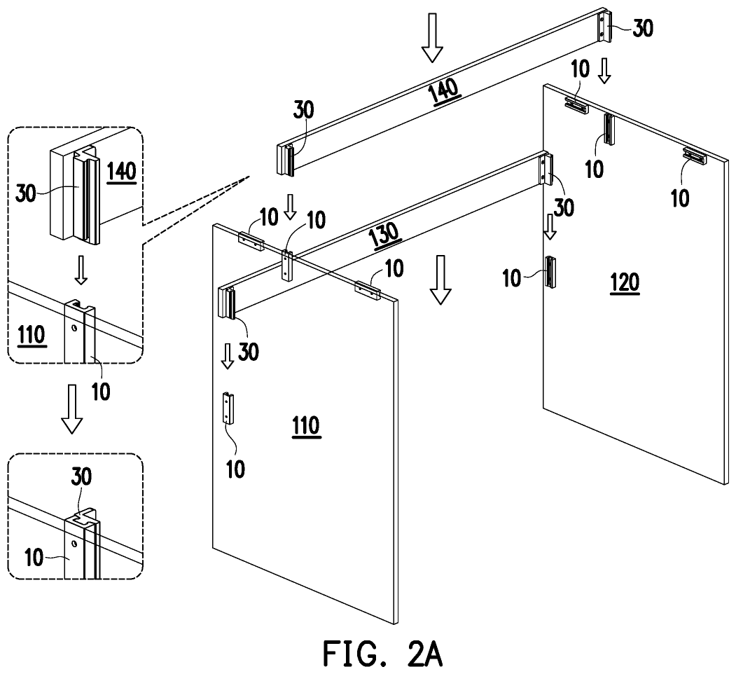

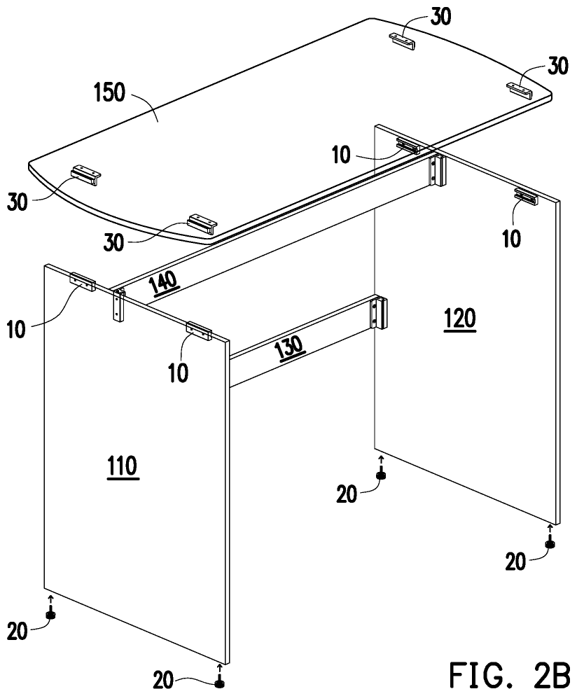

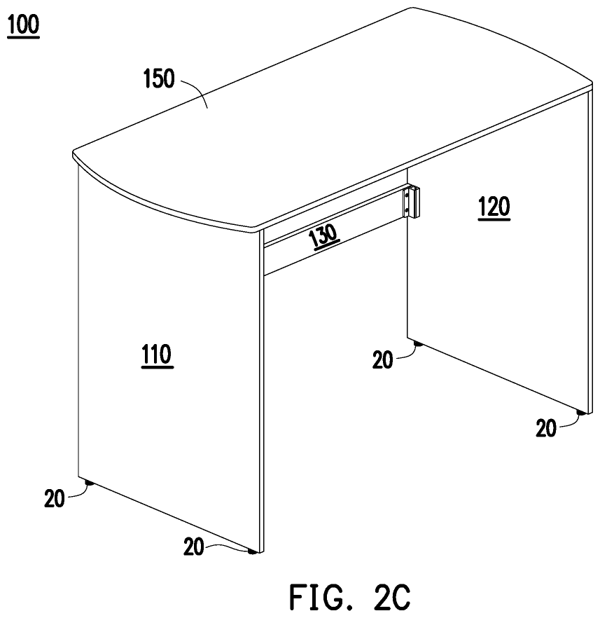

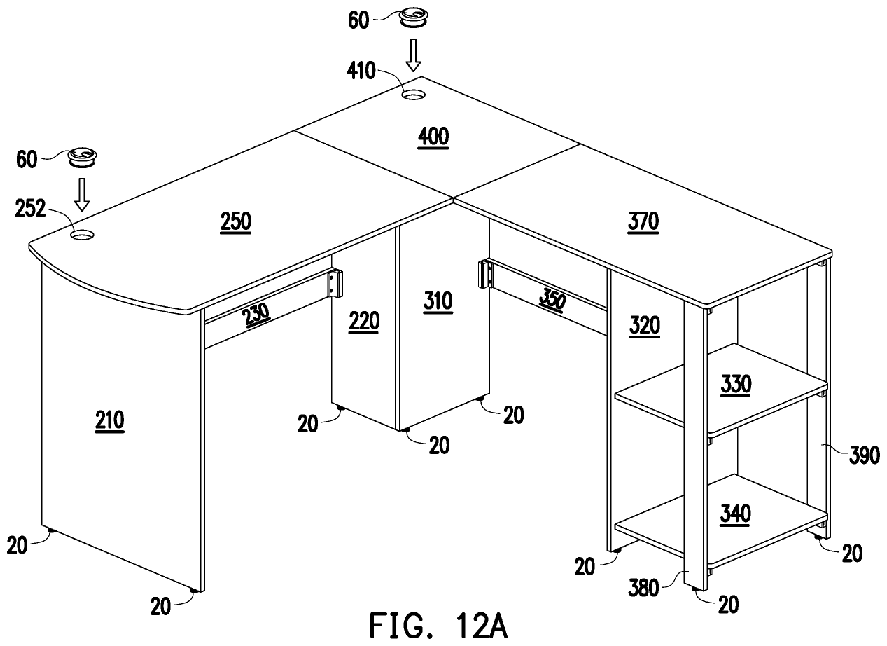

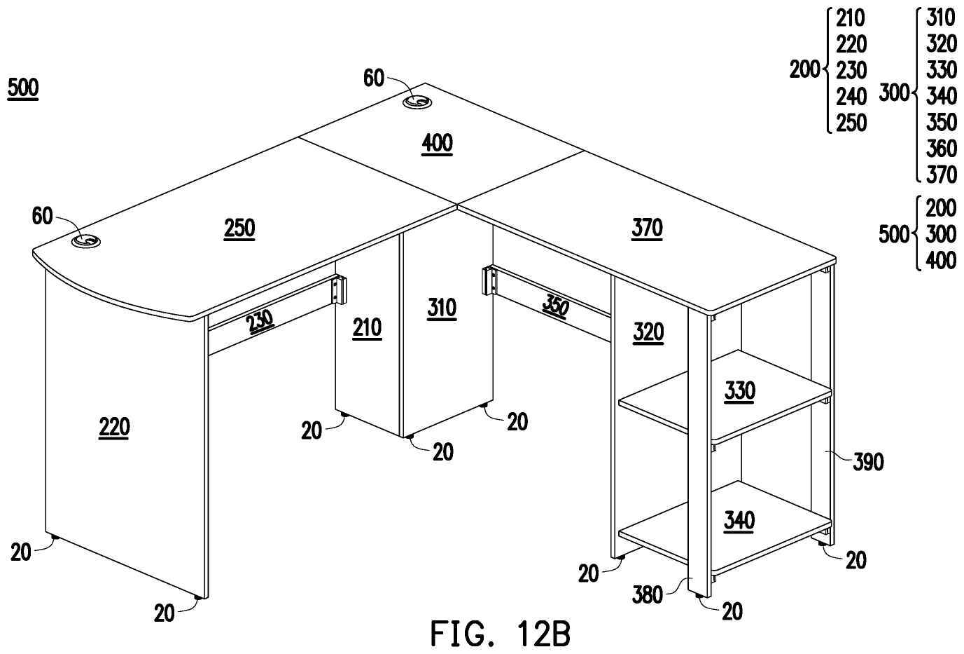

FIGS. 1A-1B show a structure of a tenon 10 and a mortise 30 utilized by a table assembly 100/500 (referring to FIG. 2C and FIG. 12B) of the present application and a mechanism of assembling thereof.

Referring to FIGS. 1A-1B, the mortise 10 utilized by the table assembly 100/500 (referring to FIG. 2C and FIG. 12B) of the present application comprises at least one hole 12. As such, although the mortises 10 are fixed at the specific locations by the manufacturer, the user could still remove them and fix the mortises 10 at any desired locations of the other components of the table assembly 100/500 (referring to FIG. 2C and FIG. 12B) such as side wall, table top, drawer base (referring to FIG. 2C and FIG. 12B) etc. via screwing or nailing through the hole 12 of the mortise 10. Therefore, the user could modify the structure and enhance the stability of the table assembly 100/500 (referring to FIG. 2C and FIG. 12B) to the desired type. The amount of the holes 12 of the mortise 10 is not limited. For example, the mortise 10 may comprise two holes as shown in other figures. The length of the mortise 10 is not limited in the present application as long as the tenon 10 could be coupled with the mortise 10.

The tenon 30 utilized by the table assembly 100/500 (referring to FIG. 2C and FIG. 12B) of the present application is generally L-shaped. Specifically, the tenon 30 comprises a shoulder 32, a tongue 34 and a plate 36. The shoulder 32, the tongue 34 and the plate 36 are molded integrally in the present application as an example but is not limited. The length of the shoulder 32 is not limited in the present application. The tongue 34 could be inserted into the mortise 10 as shown in FIG. 1B. The length of the tongue 34 is not limited in the present application as long as the tongue 34 could be fixed with the shoulder 32. The plate 36 comprises at least one hole (not separately illustrated in FIGS. 1A-1B) as the mortise 10. As such, although the tenons 30 are fixed at the specific locations by the manufacturer, the user could still remove them and fix the tenons 30 at any desired locations of the other components of the table assembly 100/500 (referring to FIG. 2C and FIG. 12B) such as side wall, table top, drawer base (referring to FIG. 2C and FIG. 12B) etc. via screwing or nailing through the hole (not separately illustrated in FIGS. 1A-1B) of the plate 36. Therefore, the user could modify the structure and enhance the stability of the table assembly 100/500 (referring to FIG. 2C and FIG. 12B) to the desired type. The amount of the hole of the plate 36 is not limited. For example, the plate 36 may comprise two holes as shown in other figures. The length of the plate 36 is not limited in the present application.

FIGS. 2A-2C show a first embodiment of the table assembly 100 of the present application and a method of assembling thereof.

Referring to FIG. 2A-2C, the table assembly 100 comprises a side wall 110, a side wall 120, a reinforcement 130, a support 140 and a table top 150. For illustrating purpose, some elements such as the side wall 110, the side wall 120, the table top 150 etc. are illustrated as transparent structure. However, the present application is not limited, all elements in the present application could be transparent, translucent or opaque as long as the table assembly 100 could be assembled via tenons 10 and mortises 30.

The side wall 110 comprises at least one mortise 10. Specifically, the side wall 110 comprises two mortises 10 disposed horizontally and two mortises 10 disposed vertically. The side wall 120 has the comprises at least one mortise 10. Similarly, the side wall 120 comprises two mortises 10 disposed horizontally and two mortises 10 disposed vertically. The amount of the mortises 10 of the side wall 110 and the side wall 120 is not limited.

The reinforcement 130 comprises two tenons 30 located at both of the ends. The reinforcement 130 is coupled to the side wall 110 and the side wall 120 by coupling one tenon 30 of the reinforcement 130 to the mortise 10 of the side wall 110; and coupling another tenon 30 of the reinforcement 130 to the mortise 10 of the side wall 120. Specifically, the tenons 30 of the reinforcement 130 are coupled to the vertical mortises 10 of the side wall 110 and the side wall 120.

The support 140 comprises two tenons 30 located at both of the ends. The support 140 is coupled to the side wall 110 and the side wall 120 by coupling one tenon 30 of the support 140 to the mortise 10 of the side wall 110; and coupling another tenon 30 of the support 140 to the mortise 10 of the side wall 120. Specifically, the tenons 30 of the support 140 are coupled to the vertical mortises 10 of the side wall 110 and the side wall 120.

The table top 150 comprises at least one tenon 30 at one edge and at least one tenon 30 at an opposite edge. Specifically, the table top 150 comprises two tenons 30 at one edge and two tenons 30 at the opposite edge but is not limited. The tenons 30 at one edge of the table top 150 are coupled to the mortises 10 of the side wall 110. More specifically, the tenons 30 at one edge of the table top 150 are coupled to the horizontally-disposed mortises 10 of the side wall 110. The tenons 30 at the opposite edge of the table top 150 are coupled to the mortises 10 of the side wall 120. More specifically, the tenons 30 at the opposite edge of the table top 150 are coupled to the horizontally-disposed mortises 10 of the side wall 120.

The pads 20 may be assembled to the side wall 110 and the side wall 120 for enhancing the stability and protecting the side walls 110/120 and the floor.

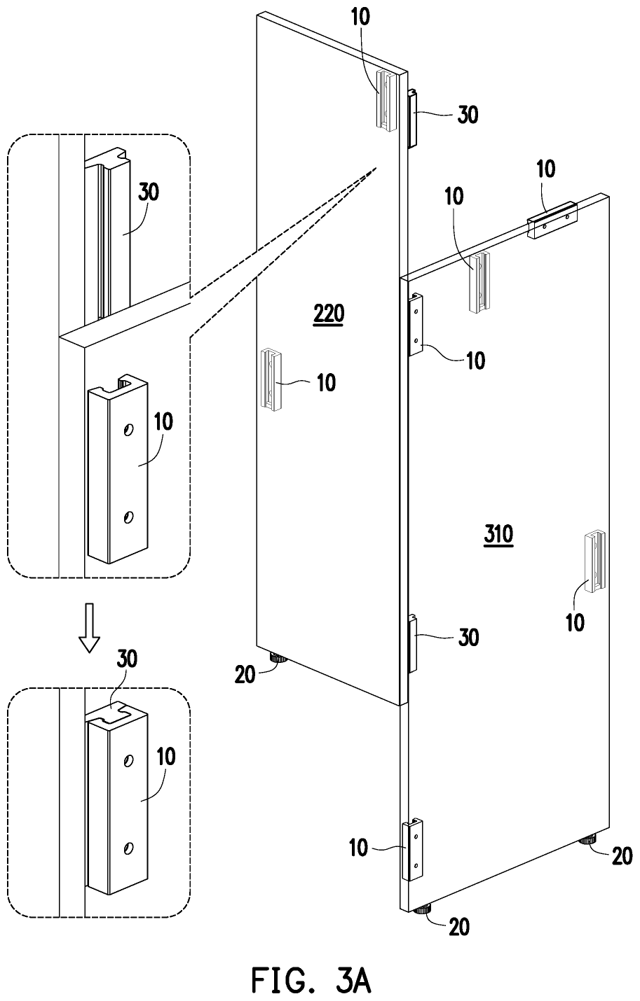

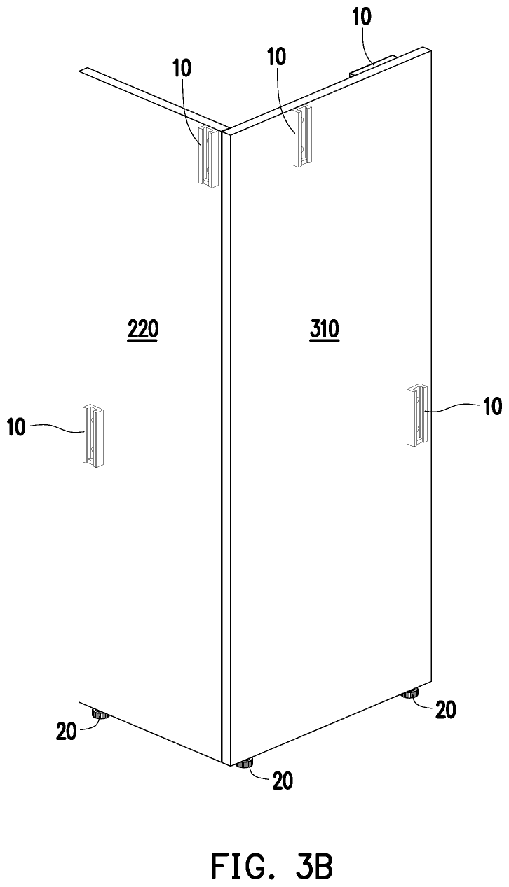

FIGS. 3A-12B show a second embodiment of the table assembly 500 of the present application and a method of assembling thereof. For illustrating purpose, some elements in FIGS. 3A-12B are illustrated as transparent structure. However, the present application is not limited, all elements in the present application could be transparent, translucent or opaque as long as the table assembly 500 could be assembled via tenons 10 and mortises 30.

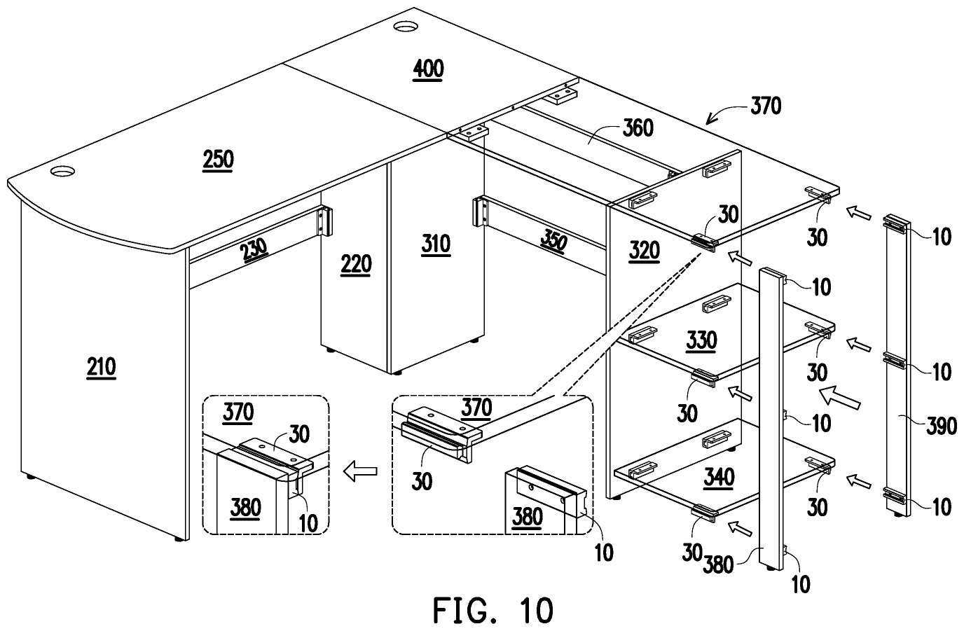

FIGS. 3A-3B show a corner portion of the table assembly 500. Referring to FIGS. 3A-3B, the corner portion of the table assembly 500 comprises a side wall 220, a side wall 310 and a table top 400 (referring to FIG. 10). The side wall 220 comprises at least one mortise 10 at one side and at least one tenon 30 at another side. More specifically, the side wall 220 in the present application comprises two vertically-disposed mortises 10 at one side and two vertically-disposed tenons 30 at another side. The amount of mortises 10 and the tenons 30 of the side wall 220 is not limited. The side wall 220 may comprise a plurality of mortises 10 and a plurality of tenons 30.

The side wall 310 comprises at least one mortise 10 at one side and at least one mortise 10 at another side. More specifically, the side wall 310 in the present application comprises two vertically-disposed mortises 10 at one side; and two vertically-disposed mortises 10 and one horizontally-disposed mortise 10 at another side. The amount of mortises 10 of the side wall 310 is not limited. The side wall 310 may comprise a plurality of mortises 10.

As shown in FIGS. 3A-3B, the tenons 30 of the side wall 220 is coupled to the mortises 10 of the side wall 310.

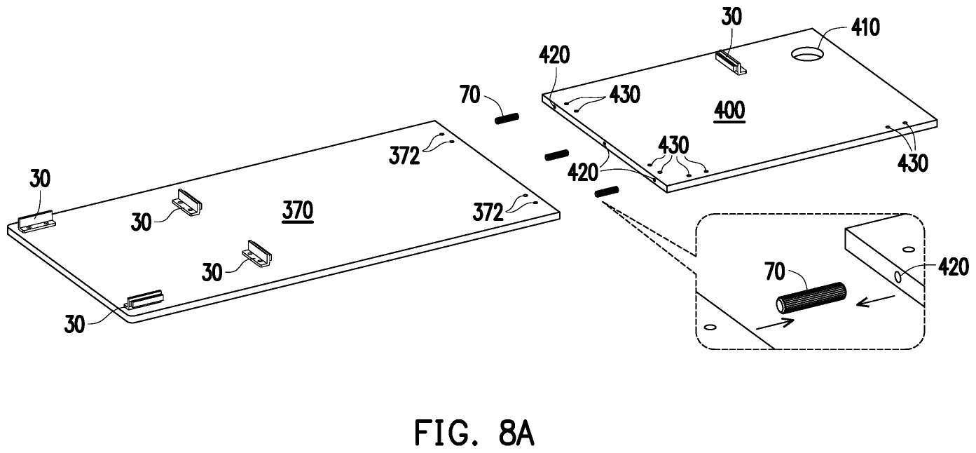

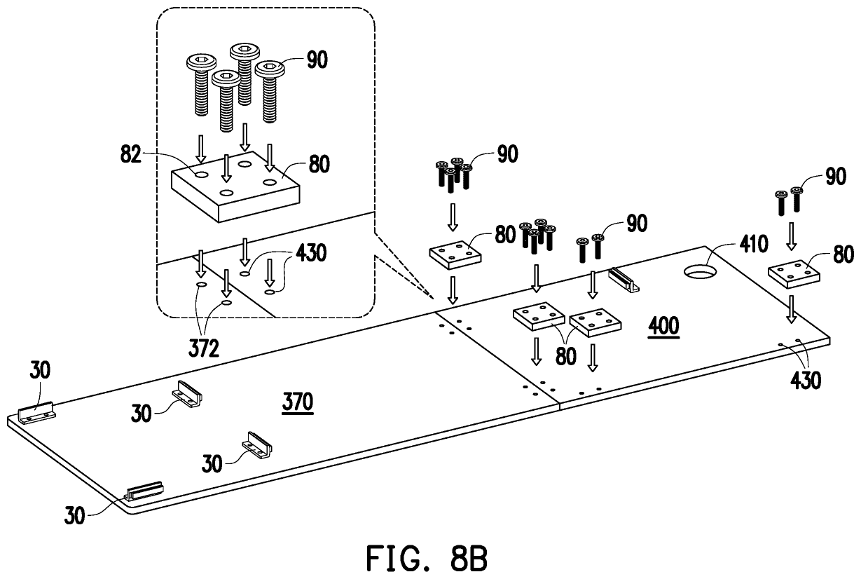

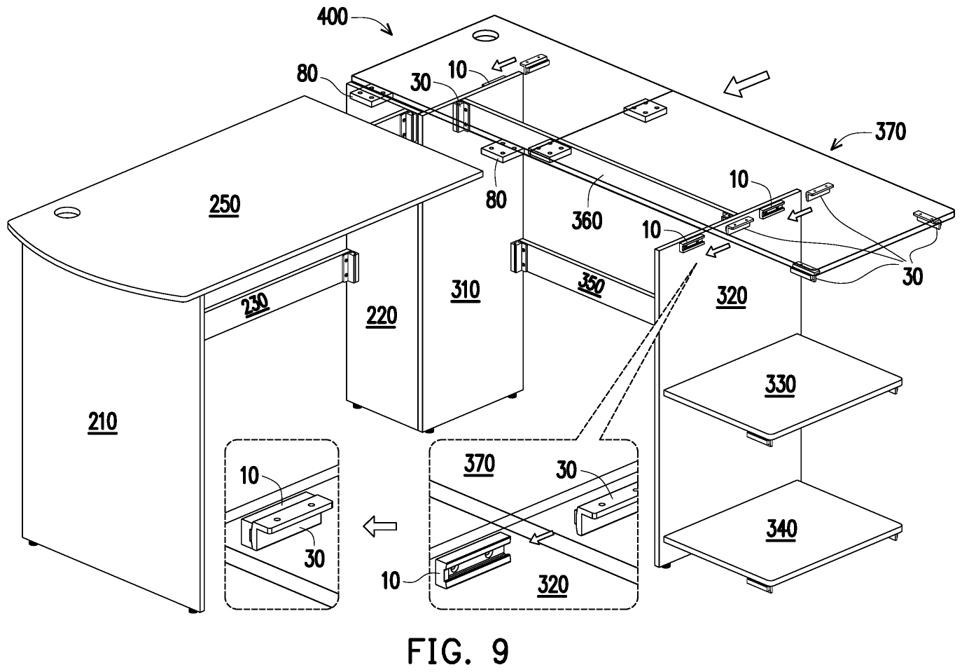

The table top 400 (referring to FIG. 9) will be described later with FIGS. 8A-9).

The pads 20 may be assembled to the side wall 220 and the side wall 310 for enhancing the stability and protecting the side walls 220/310 and the floor.

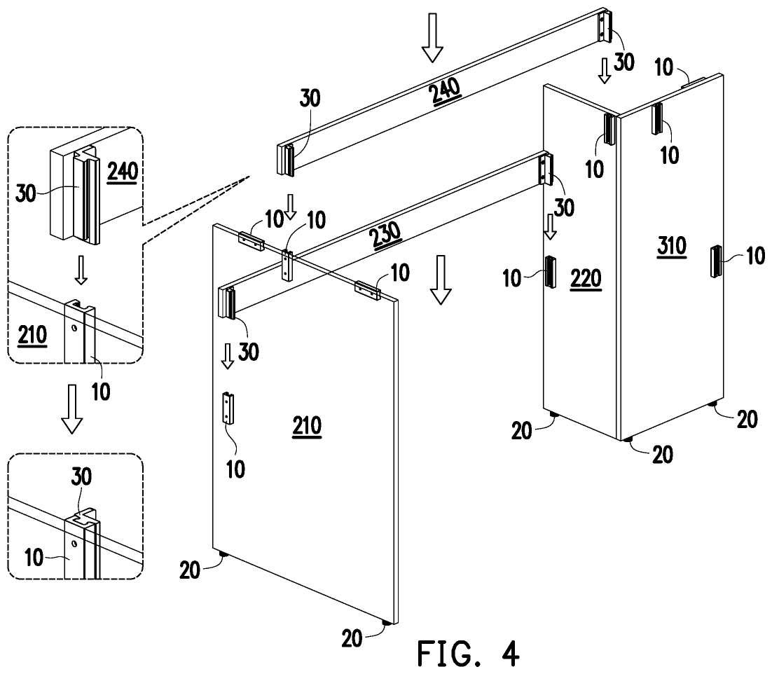

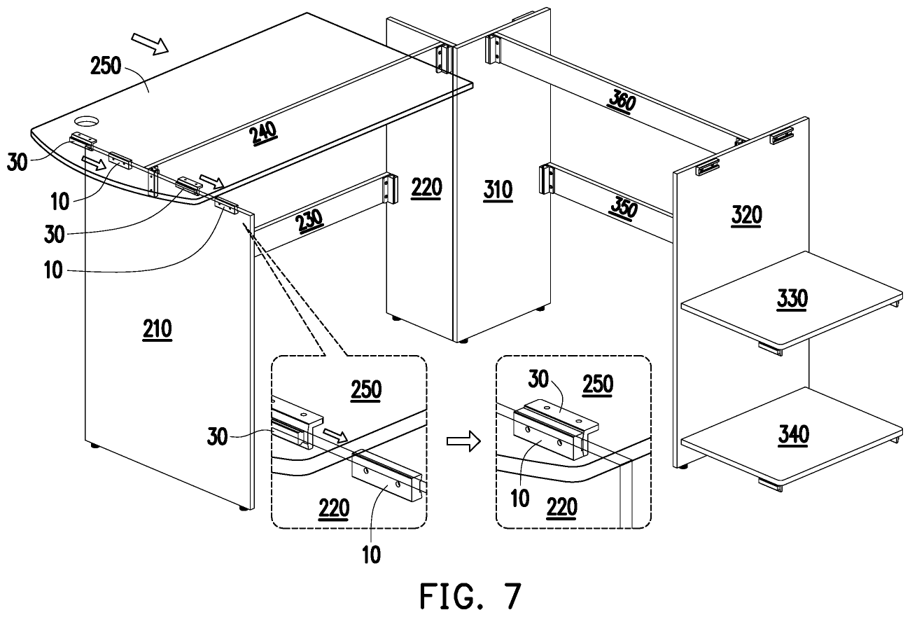

FIG. 4 shows a first table portion of the table assembly 500. Referring to FIG. 4, the first table portion of the table assembly 500 comprises a side wall 210, a side wall 220, a reinforcement 230, a support 240 and a table top 250 (referring to FIG. 7).

The side wall 210 comprises a plurality of mortises 10. In the present application, the side wall 210 comprises two vertically-disposed mortises 10 and two horizontally-disposed mortises 10. However, the amount of the mortise 10 of the side wall 210 is not limited as long as the reinforcement 230, the support 240 and the table top 250 (referring to FIG. 7) could be assembled.

The side wall 220 is shared by the first table portion and the corner portion.

The reinforcement 230 comprises two tenons 30. The reinforcement 230 is coupled to the side wall 210 via coupling one of the tenons 30 of the reinforcement 230 to the mortise 10 of the side wall 210; and coupling another one of the tenons 30 of the reinforcement 230 to the mortise 10 of the side wall 220. The amount of the tenons 30 of the reinforcement 230 is not limited. For example, the reinforcement 230 may be coupled to the side wall 210 via coupling two shorter tenons (not separately illustrated) to the mortise(s) of the side wall 210.

The support 240 comprises two tenons 30. The support 240 is coupled to the side wall 210 via coupling one of the tenons 30 of the support 240 to the mortise 10 of the side wall 210; and coupling another one of the tenons 30 of the support 240 to the mortise 10 of the side wall 220. The amount of the tenons 30 of the support 230 is not limited. For example, the support 230 may be coupled to the side wall 210 via coupling two shorter tenons (not separately illustrated) to the mortise(s) of the side wall 210.

The table top 250 (referring to FIG. 7) is supported by the support 240 and will be describe later with FIG. 7.

Similarly, the pads 20 may be assembled to the side wall 210 for enhancing the stability and protecting the side wall 210 and the floor.

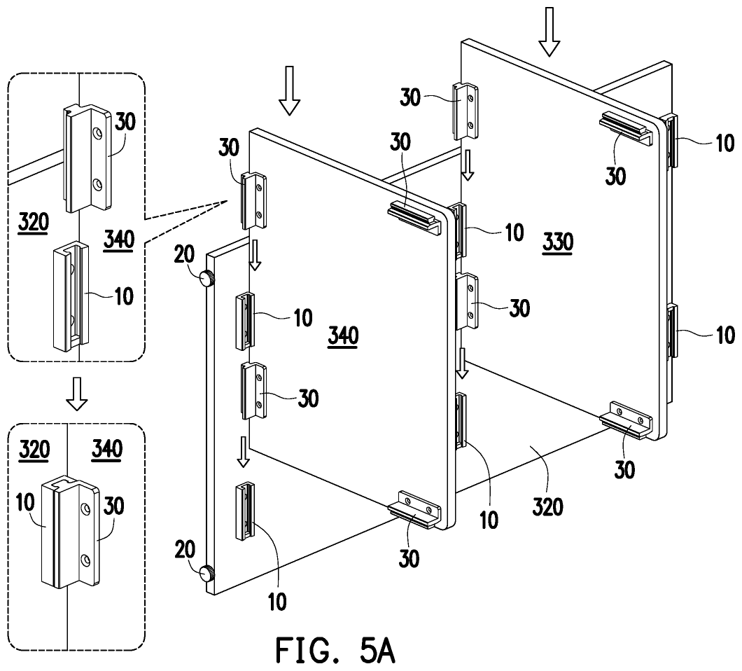

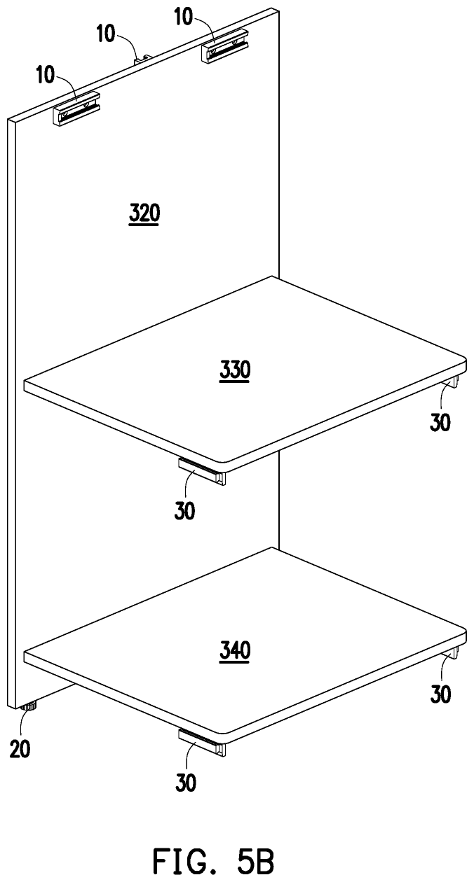

FIGS. 5A-5B show a shelf portion of the table assembly 500. Referring to FIGS. 5A-5B, the shelf portion of the table assembly 500 comprises a side wall 320, a shelf base 330 and a shelf base 340.

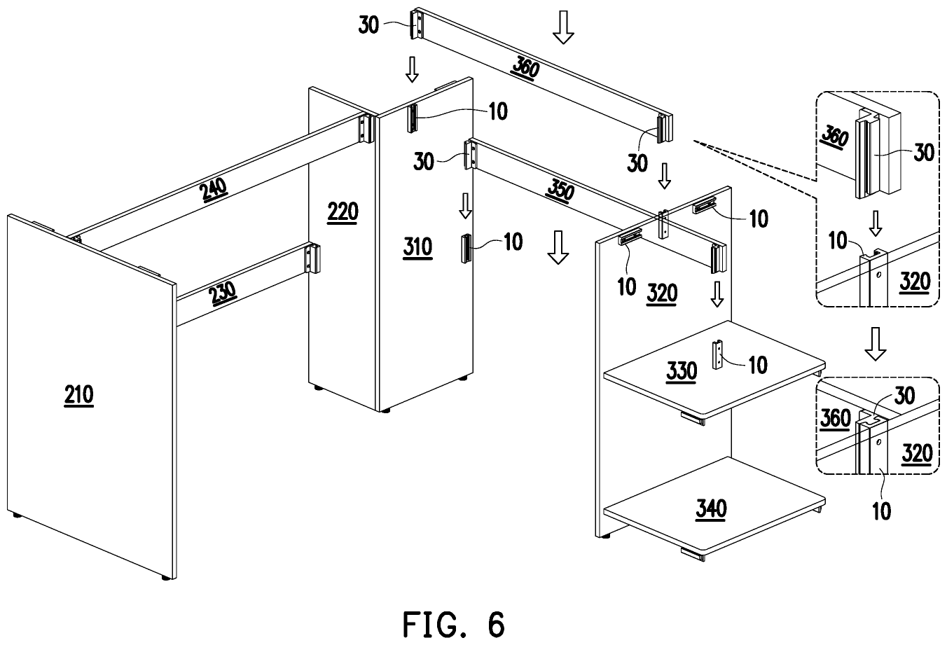

The side wall 320 comprises a plurality of mortises 10. In the present application, the side wall 320 comprises two vertically-disposed mortises 10 (as shown in FIG. 5B and FIG. 6) and six horizontally-disposed mortises 10. However, the amount of mortise 10 of the side wall 3200 is not limited as long as the shelf base 330, the shelf base 340, the reinforcement 350 (referring to FIG. 6), the support 360 (referring to FIG. 6), the table top 370 (referring to FIG. 9) could be assembled.

Similarly, the pads 20 may be assembled to the side wall 320 for enhancing the stability and protecting the side wall 320 and the floor.

The shelf base 330 comprises a plurality of tenons 30. In the present application, the shelf base 330 comprises two vertically-disposed tenons 30 and two horizontally-disposed tenons 30. The shelf base 330 is coupled to the side wall 320 via coupling the tenons 30 of the shelf base 330 to the mortises 10 of the side wall 320. The amount of tenons 30 of the shelf base 330 and the amount of mortises 10 of the side wall 320 coupled together are not limited as long as the shelf base 330 can be coupled to the side wall 320.

The shelf base 340 comprises a plurality of tenons 30. In the present application, the shelf base 340 comprises two vertically-disposed tenons 30 and two horizontally-disposed tenons 30. The shelf base 340 is coupled to the side wall 320 via coupling the tenons 30 of the shelf base 340 to the mortises 10 of the side wall 320. The amount of tenons 30 of the shelf base 340 and the amount of mortises 10 of the side wall 320 coupled together are not limited as long as the shelf base 340 can be coupled to the side wall 320.

FIG. 6 shows a second table portion of the table assembly 500. Referring to FIG. 6, the second table portion of the table assembly 500 comprises the side wall 310, the side wall 320, a reinforcement 350, a support 360 and a table top 370 (referring to FIG. 9).

The side wall 310 is shared by the corner portion and the second table portion.

The side wall 320 is shared by the shelf portion and the second table portion.

The reinforcement 350 comprises two tenons 30. The reinforcement 350 is coupled to the side wall 310 via coupling one of the tenons 30 of the reinforcement 350 to the mortise 10 of the side wall 310; and coupling another one of the tenons 30 of the reinforcement 350 to the mortise 10 of the side wall 320. The amount of the tenons 30 of the reinforcement 350 is not limited. For example, the reinforcement 350 may be coupled to the side wall 310 via coupling two shorter tenons (not separately illustrated) to the mortise(s) of the side wall 310.

The support 360 comprises two tenons 30. The support 360 is coupled to the side wall 310 via coupling one of the tenons 30 of the support 360 to the mortise 10 of the side wall 310; and coupling another one of the tenons 30 of the support 360 to the mortise 10 of the side wall 320. The amount of the tenons 30 of the support 360 is not limited. For example, the support 360 may be coupled to the side wall 310 via coupling two shorter tenons (not separately illustrated) to the mortise(s) of the side wall 310.

The table top 370 (referring to FIG. 9) is supported by the support 360 and will be describe later with FIGS. 8A-9.

FIG. 7 shows a mechanism of assembling the table top 240. Referring to FIG. 7, the table top 270 comprises at least one tenon 30. In the present application, the table top 270 comprises two tenons 30 as an example but is not limited. The table top 240 is coupled to the side wall 210 via coupling the tenons 30 with the mortises 210 of the side wall 210. The table top 240 is also supported by the support 240.

FIGS. 8A-8B show a mechanism of assembling the table top 370 and the table top 400. For assembling the table top 370 and the table top 400, the table assembly 500 further comprises at least one connector 70, at least one fixing plate 80 and a plurality screws 90. The table assembly 500 comprises three connectors 70 and four fixing plates 80 as an example but is not limited.

In the present application, the connector 70 is a rod as an example. Each of the fixing plates 80 comprises at least two screw holes 82. In the present application, each of the fixing plates 80 comprises four screw holes 82 as an example but is not limited.

The table top 370 comprises a plurality of tenons 30. Specifically, the table top 370 comprises two vertically-disposed tenons 30 and two horizontally-disposed tenons 30 but is not limited. In addition, table top 370 further comprises at least one side hole (not separately illustrated) and at least one screw hole 372.

The table top 400 comprises at least one tenon 30. Specifically, the table top 400 comprises one tenon 30 as an example but is not limited. In addition, table top 400 further comprises at least one side hole 420 and at least one screw hole 430.

As shown in FIG. 8A, the table top 370 and the table top 400 are assembled by inserting one end of the connector 70 to the side hole (not separately illustrated) of the table top 370; and inserting another one end of the connector 70 to the side hole 420 of the table top 400.

In the present application, the table assembly 500 comprises three connectors 70 as an example but is not limited. In addition, the table top 370 comprises three side holes (not separately illustrated) and the table top 400 comprises three side holes 420 as an example.

As shown in FIG. 8B, the fixing plates 80 is screwed to the table top 370 and the table top 400. Specifically, half of the fixing plate 80 is screwed to the table top 370 by the screws 90 and another half of the fixing plate 80 is screwed to the table top 400 by the screws 90. As such, the table top 370 and the table top 400 can be assembled more stably. In detail, each of the fixing plates 80 comprises four screw holes 82. Two of the screw holes 82 of the fixing plates 80 is corresponded to the screw holes 372 of the table top 370. Another two of the screw holes 82 of the fixing plates 80 is corresponded to the screw holes 430 of the table top 400. However, the present application is not limited. For example, only one screw hole 82 of the fixing plate 80 may be corresponded to one screw hole 430 of the table top 400; while three screw holes 82 of the fixing plate 80 may be corresponded to three screw holes 372 of the table top 370. The amount of screw holes of the fixing plate 80, the table top 370 and the table top 400 is not limited.

There are two fixing plates 80 screwed between the table top 370 and the table top 400 by the above method. However, the present application is not limited by the amount of the fixing plate 80. In addition, the table top 370 comprises four screw holes 372 for cooperating the amount of the fixing plates 80. However, the present application is not limited. For example, the table top 370 may only comprise two screw holes 372 if there is only one fixing plate 80. Another example is that the fixing plate 80 may only comprise two screw holes 82 shared by the table top 370 and the table top 400. In such case, the table top 370 may only comprise one screw hole 372.

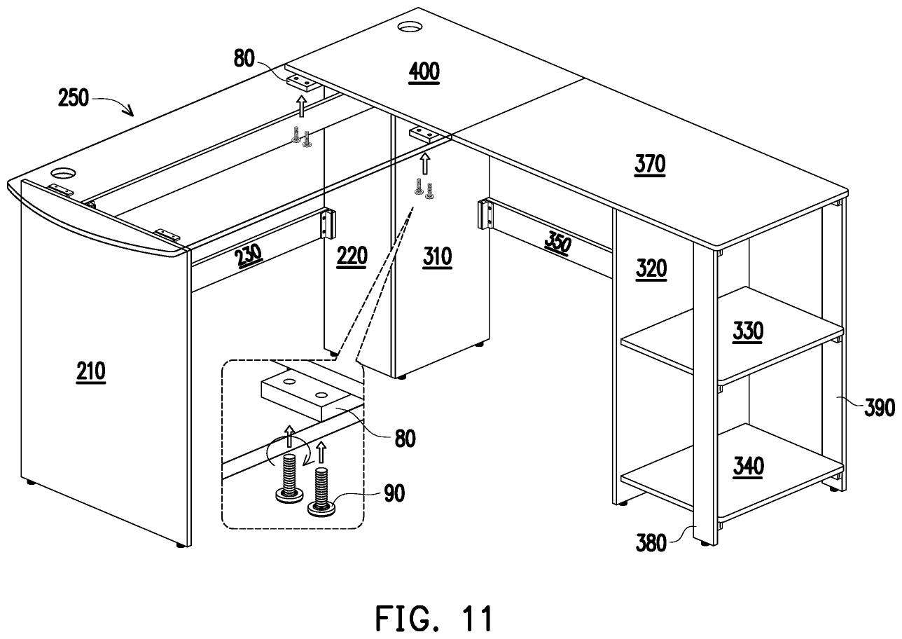

Referring to FIG. 8B, the another two fixing plates 80 may be screwed to the table top 400. As the structure mentioned above, only half of each of the fixing plates 80 is screwed to the table top 400. Another half of each of the fixing plate 80 will be screwed to the table top 250 (referring to FIG. 11). The details will be described later with FIG. 11.

Similarly, the amount of fixing plates 80 for assembling the table top 400 and the table top 250 (referring to FIG. 11) is not limited. In addition, the screw holes 430 of the table top 400 is not limited.

FIG. 9 shows a mechanism for assembling the table top 400 and the table top 370 to the corner portion and the second table portion.

Specifically, the corner table top 400 is coupled to the side wall 220 and the side wall 310 by coupling the tenon 10 of the table top 400 to the mortises 30 of the side wall 310. In addition, the table top 370 is coupled to the side wall 320 by coupling the tenons 10 of the table top 370 to the mortises 30 of the side wall 320.

FIG. 10 shows a mechanism of assembling the shelf portion. The shelf portion of the table assembly 500 further comprises a shelf wall 380 and a shelf wall 390.

The shelf wall 380 comprises a plurality of tenons 30. In the present application, the shelf wall 380 comprises three tenons 30 for coupling to the mortise 10 of the table top 370, the mortise 10 of the shelf base 330 and the mortise 10 of the shelf base 340. However, the present application is not limited. For example, the shelf wall 380 may comprise several shorter tenons to couple with the mortises 10.

The structure of the shelf wall 390 is the same as the structure of the shelf wall 380 in the present application. However, the present application is not limited. The structure of the shelf wall 390 may be different from the shelf wall 380 as long as the shelf wall 390 can be coupled to the table top 370, the shelf base 330 and the shelf base 340.

FIG. 11 shows a mechanism of fixing the table top 250 and the table top 400. As previously described, the table top 250 and the table top 400 are fixed together by screwing the fixing plates 80 by the screws 90. Similarly, the amount of fixing plates 80 and the amount of screw holes are not limited in the present application as long as the table top 250 and the table top 400 can be fixed stably.

FIGS. 12A-12B shows a mechanism of assembling sorters 60.

Referring to FIG. 12A, the table top 250 further comprises a sorter hole 252 and the table top 400 further comprises a sorter hole 410. The table assembly 500 further comprises the sorters 60. The table assembly 500 of the present application comprises two sorters 60 as an example but is not limited. The sorters 60 are inserted to the sorter hole 410 of the table assembly 400 and the sorter hole 252 of the table assembly 250 respectively.

Based on the above, the table assembly of the present application allows user to assemble the table assembly simply via coupling the tenons to the mortises. There is no need to prepare hammer or nails etc. by the user. However, if the user would like to have the overall structure more stable, the fixing plate may still be utilized for enhancing the stability, wherein only few screws are required. Moreover, the connector may also combine the table tops more stably.

In addition, the location of the tenons and the mortises are interchangeable since the tenons and the mortises comprise at least one hole on each of them for fixing at the side wall, table top, drawer base etc. As such, the user may modify the overall structure and increase or decrease the tenons and the mortises by themselves for enhance the stability or change the style of the table assembly.

It will be apparent to those skilled in the art that various modifications and variations can be made to the structure of the present application without departing from the scope or spirit of the present application. In view of the foregoing, it is intended that the present application cover modifications and variations of this application provided they fall within the scope of the following claims and their equivalents.

What is claimed is:

1. A table assembly, comprising:
a first side wall comprising at least one first side wall mortise;
a second side wall comprising at least one second side wall mortise; and
a table top comprising at least one first table top tenon at one edge and at least one second table top tenon at an opposite edge, the table assembly is assembled via coupling the at least one first table top tenon to the at least one first side wall mortise and coupling the at least one second table top tenon to the at least one second side wall mortise.

2. The table assembly as claimed in claim 1, wherein the first side wall comprises two first side wall mortises and the second side wall comprises two second side wall mortises, the table top comprises two first table top tenons and two second table top tenons.

3. The table assembly as claimed in claim 1, further comprising a support comprising two support tenons, wherein the first side wall comprises at least two first side wall mortises and the second side wall comprises at least two second side wall mortises, wherein
the support is coupled to the first side wall via coupling one of the support tenons to one of the first side wall mortise and coupling another one of the support tenons to one of the second side wall mortises; and
the table top is coupled to the first side wall via coupling the first table top tenon to another one of the first side wall mortises and coupling the second table top tenon to another one of the second side wall mortises.

4. The table assembly as claimed in claim 1, further comprising a reinforcement comprising two reinforcement tenons, wherein the first side wall comprises at least two first side wall mortises and the second side wall comprises at least two second side wall mortises, wherein
the reinforcement is coupled to the first side wall via coupling one of the reinforcement tenons to one of the first side wall mortise and coupling another one of the reinforcement tenons to one of the second side wall mortises; and
the table top is coupled to the first side wall via coupling the first table top tenon to another one of the first side wall mortises and coupling the second table top tenon to another one of the second side wall mortises.

5. A method for assembling a table assembly, wherein the table assembly comprises:
a first side wall comprising a plurality of first side wall mortises;
a second side wall comprising a plurality of second side wall mortises;
a first table top comprising at least one first table top tenon; and
a first support comprising two first support tenons;
the method comprises:
coupling the first support to the first side wall by coupling one of the first support tenons to the first side wall mortise;
coupling the first support to the second side wall by coupling another one of the first support tenons to the second side wall mortise; and
coupling the first table top to the first side wall via coupling the first table top tenon to the first side wall mortise, wherein the first table top is supported by the first support.

6. The method of assembly the table assembly as claimed in claim 5, further comprising:
coupling a first reinforcement to the first side wall, wherein the first reinforcement comprises two first reinforcement tenons, the first reinforcement is coupled to the first side wall by coupling one of the first reinforcement tenons to the first side wall mortise; and
coupling another one of the first reinforcement tenons to the second side wall mortise of the second side wall.

7. The method of assembly the table assembly as claimed in claim 5, wherein before the step of coupling the support to the first side wall, the method further comprises:
coupling a third side wall to the second side wall, wherein the third side wall comprises a plurality of third side wall mortises and the second side wall further comprises a plurality of second side wall tenons, the third side wall is coupled to the second side wall by coupling the second side wall tenons to the third side wall mortises.

8. The method of assembly the table assembly as claimed in claim 7, wherein the table assembly further comprises:
a fourth side wall comprising a plurality of fourth side wall mortises;
a first shelf base comprising a plurality of first shelf base tenons; and
a second shelf base comprising a plurality of second shelf base tenons;
the method further comprising:
coupling a first shelf base to the fourth side wall by coupling the first shelf base tenons to the fourth side wall mortises; and
coupling a second shelf base to the fourth side wall by coupling the second shelf base tenons to the fourth side wall mortises.

9. The method of assembly the table assembly as claimed in claim 8, further comprising:
coupling a second support to the third side wall, wherein the second support comprises two second support tenons, the second support is coupled to the third side wall by coupling one of the second support tenons to the third side wall mortise; and
coupling another one of the second support tenons to the fourth side wall mortise of the fourth side wall.

10. The method of assembly the table assembly as claimed in claim 8, further comprising:
coupling a second reinforcement to the third side wall, wherein the second reinforcement comprises two second reinforcement tenons, the second reinforcement is coupled to the third side wall by coupling one of the second reinforcement tenons to the third side wall mortise; and
coupling another one of the second reinforcement tenons to the fourth side wall mortise of the fourth side wall.

11. The method of assembly the table assembly as claimed in claim 9, wherein the table assembly further comprises:
a second table top comprising a plurality of second table top tenons and at least one second table top side hole;
a corner table top comprising a plurality of corner table top tenons and at least one corner table top side hole; and
at least one connector;
the method further comprising:
assembling the table top and the corner table top by inserting one end of the connector to the second table top side hole, and inserting another one end of the connector to the corner table top side hole.

12. The method of assembly the table assembly as claimed in claim 11, wherein the table assembly further comprises a fixing plate comprising at least two fixing plate screw holes, the second table top further comprises at least one second table top screw hole, the corner table top further comprises at least one corner table top screw hole,
the method further comprising:
screwing through one of the fixing plate screw holes and the second table top screw hole; and
screwing through another one of the fixing plate screw holes and the corner table top screw hole.

13. The method of assembly the table assembly as claimed in claim 11, after assembling the table top and the corner table top, the method further comprising:
coupling the second table top to the fourth side wall by coupling the second table top tenons to the fourth side wall mortises; and
coupling the corner table top to the third side wall by coupling the corner table top tenons to the third side wall mortises.

14. The method of assembly the table assembly as claimed in claim 13, wherein the table assembly further comprises a fixing plate comprising at least two fixing plate screw holes, the first table top further comprises at least one first table top screw hole, the corner table top further comprises at least one corner table top screw hole,
wherein before the step of coupling the second table top to the fourth side wall, the method further comprises screwing through one of the fixing plate screw holes and the corner table top screw hole, wherein after coupling the corner table top to the third side wall, the method further comprises screwing another one of the fixing plate screw holes and the first table top screw hole.

15. The method of assembly the table assembly as claimed in claim 13, wherein the table assembly further comprises a first shelf wall comprising a plurality of first shelf wall mortises, the method further comprises coupling the first shelf side wall to the second table top, the first shelf base and the second shelf base by coupling the second table top tenon, the first shelf base tenon and the second shelf base tenon to the first shelf side wall mortises.

16. The method of assembly the table assembly as claimed in claim 15, wherein the table assembly further comprises a second shelf wall comprising a plurality of second shelf wall mortises, the method further comprises coupling the second shelf wall to the second table top, the first shelf base and the second shelf base by coupling the second table top tenon, the first shelf base tenon and the second shelf base tenon to the second shelf side wall mortises.

17. The method of assembly the table assembly as claimed in claim 13, wherein the table assembly further comprises a sorter, the corner table top further comprises a sorter hole, the method further comprises inserting the sorter to the sorter hole.

18. The method of assembly the table assembly as claimed in claim 5, wherein the table assembly further comprises a sorter, the first table top further comprises a sorter hole, the method further comprises inserting the sorter to the sorter hole.
